(19) United States
(12) Patent Application Publication
(10) Pub. No.: US 2010/0098216 A1
(43) Pub. Date: Apr. 22, 2010

(54) Noise Reduction In Xray Emitter/Detector Systems

(75) Inventor: Kurt Dobson, Midvale, UT (US)

Correspondence Address: THORPE NORTH & WESTERN, LLP., P.O. Box 1219, SANDY, UT, 84091-1219, US

(73) Assignee: MOXTEK, INC., Orem, UT (US)

(21) Appl. No.: 12/253,531

(22) Filed: Oct. 17, 2008

(51) Int. Cl. H05G 1/12; H05G 1/10

(52) U.S. Cl. 378/104; 378/101

(57) ABSTRACT

Systems and methods for reducing signal noise in an x-ray emitter/detector system are disclosed. A common clock is connected to at least two subsystems of the x-ray emitter/detector system to enable a plurality of noise sources associated with the at least two subsystems within the x-ray emitter/detector system to be correlated with the common clock. At least one adaptive filter having a plurality of taps is configured to receive a desired signal and a correlated noise estimate signal and output an error signal. An update algorithm is used to update a value of the plurality of taps to minimize the error signal output to thereby substantially remove at least one of the plurality of noise sources at each of the at last one variable filters in the x-ray emitter/detector system to provide a more accurate display of the output of the x-ray emitter/detector system.

### BACKGROUND

Modern x-ray systems are typically composed of a number of individual subsystems. Each of these subsystems is either a generator of noise or an inadvertent detector of noise. For example, an x-ray source is typically driven by a high-voltage switching power supply. The power supply can switch at a frequency of tens to hundreds of kilohertz. As the power supply switches to produce a bias of tens of kilovolts, both mechanical and electromagnetic fields are emitted, often at several frequencies.

Because of the extremely high gain of x-ray detectors, the detectors act as an unintentional broadband microphone for detecting mechanical vibrations into the hundreds of kilohertz, vibrational frequencies that are characteristically produced by the high voltage switching power supplies. In addition, any mechanical noise in a users' environment is often picked up by the x-ray detector. X-ray detectors are also extremely sensitive to electromagnetic fields, which may be coupled to the detectors in a variety of unintended manners. Any of these vibrational or electromagnetic noise signals can lower the effective resolution of the overall x-ray system.

The front-end electronics for detector systems deal with small signal levels having very low signal to noise ratios. The front-end electronics are therefore also susceptible to picking up unwanted noise.

In order to minimize the amount of electromagnetic and mechanical noise produced in and detected by x-ray systems, the individual subsystems are typically formed as separate modules in an attempt to contain their inherent mechanical and electromagnetic emissions. These separate modules can add considerable cost and complexity to the resulting system. Additionally, modern x-ray systems packaging has approached the physical limitations of the packaging to further reduce mechanical and electrical noise. The subsystems cannot completely eliminate all of the possible coupling modes. The overall affect of the various mechanical and electrical coupling modes can be daunting to understand. For example, changing the packaging of one subsystem to reduce physical vibrations can create unintended noise consequences on another subsystem.

As x-ray detectors continue to improve, subsystem coupling mechanisms are quickly becoming the limiting factor in x-ray fluorescence and x-ray diffraction system performance.

### SUMMARY OF THE INVENTION

Systems and methods for reducing signal noise in an x-ray emitter/detector system are disclosed. One system includes a common clock that is connected to at least two subsystems of the x-ray emitter/detector system to enable a plurality of noise sources associated with the at least two subsystems within the x-ray emitter/detector system to be correlated with the common clock. At least one adaptive filter having a plurality of taps is configured to receive a desired signal and a correlated noise estimate signal and output an error signal. An update algorithm is used to update a value of the plurality of taps to minimize the error signal output to thereby substantially remove at least one of the plurality of noise sources at each of the at last one variable filters in the x-ray emitter/detector system to provide a more accurate display of the output of the x-ray emitter/detector system.

Another system for reducing signal noise in an x-ray emitter/detector system includes a plurality of adaptive filters. The system comprises a first correlated noise estimate of a first noise source on a signal in the x-ray emitter/detector system. A first of the plurality of adaptive filters is configured to receive the first correlated noise estimate to enable noise related to the first noise source to be substantially removed from the signal and output a filtered signal substantially free of the noise related to the first noise source. The system also includes an additional correlated noise estimate of a further noise source on the signal in the x-ray emitter/detector system. A subsequent adaptive filter of the plurality of adaptive filters is configured to receive the filtered signal and the additional correlated noise estimate to enable noise related to the further noise source to be substantially removed from the filtered signal and output a further filtered signal substantially free of the further noise source to enable a plurality of noise sources on the signal to be removed in the x-ray emitter/detector system using the plurality of adaptive filters to provide a more accurate display of the signal.

A method for reducing signal noise in an x-ray emitter/detector system is also disclosed. The method includes the operation of providing a common clock connected to at least two subsystems of the x-ray emitter/detector system to enable a plurality of noise sources associated with the at least two subsystems within the x-ray emitter/detector system to be correlated with the common clock. At least one of the plurality of noise sources is filtered using an adaptive filter having a plurality of taps configured to receive a desired signal and a correlated noise estimate signal and output an error signal. A value of the plurality of taps is updated with an update algorithm to minimize the error signal output to thereby substantially remove the at least one noise source at the adaptive filters in the x-ray emitter/detector system to provide a more accurate display of an output of the x-ray emitter/detector system.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a block diagram of a traditional x-ray emitter/detector system;

FIG. 2 is an illustration of an x-ray emitter/detector system architecture using a master clock at the system level to connect subsystem components in accordance with an embodiment of the present invention;

FIG. 3 is a block diagram of an adaptive filter;

FIG. 4 is an illustration of an x-ray emitter/detector system that includes a first and second adaptive filter connected in series in accordance with an embodiment of the present invention;

FIG. 5 is an illustration of an x-ray emitter/detector system incorporating a plurality of adaptive filters to filter a plurality of noise sources in accordance with an embodiment of the present invention; and

FIG. 6 is a flow chart depicting a method for reducing signal noise in an x-ray emitter/detector system in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

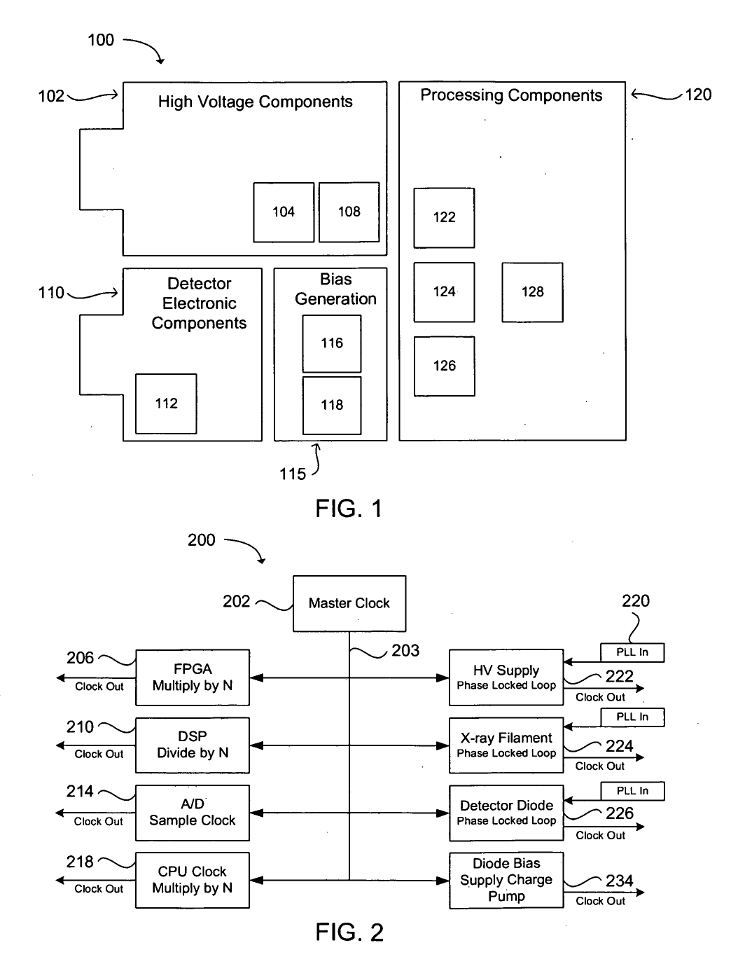

In order to minimize mechanical and electromagnetic noise, typical x-ray systems are divided into separate subsystems. For example, FIG. 1 shows a high level block diagram of a traditional x-ray system 100 divided into at least three separate sections. A first subsystem 102 typically includes the high voltage components such as the high voltage power supply 104 and x-ray tube filament supply 108. As previously discussed in the background section, these components can produce a relatively large amount of mechanical and electromagnetic noise during standard operation. Two oscillators are typically used in this subsystem. The first oscillator is used to drive the high voltage multiplier supply, typically at a frequency of 100 kHz. The second oscillator is used to drive the filament in the x-ray tube, for example at a frequency of approximately 200 kHz. These frequencies can change as control parameters change. The frequencies also change in response to drifts in temperature.

A second subsystem 110 includes detector electronic components. This is typically an analog electronics module so there are usually no internal clock sources. In some types of systems, a ramp signal 112 is generated asynchronously. The ramp signal can range from less than 1 Hz to several kilohertz. X-rays events received at the detector module and converted to electronic signals are non-deterministic in time.

A third subsystem 115 can include detector bias generation components. X-ray detector diodes require a bias generator, in this example, 130 volts. Generally, the system electronics contain a charge-pump and feedback control 118 to generate the bias. This control is typically clocked asynchronously to the components in the other subsystems.

A fourth subsystem 120 includes processing components used in the creation and detection of x-rays. The components may include a field programmable gate array (FPGA) 122, a digital signal processor 124, an analog to digital converter 126, and a central processing unit 128. Each of these components may be driven with separate clock sources.

From a systems architecture perspective, the large number of asynchronous signals present in a typical x-ray emitter/detector system makes periodic noise source timing extremely difficult. Therefore, to overcome the mechanical and electrical noise, the various sub-systems have been carefully packaged and shielded to minimize the transference of noise to other components in the system.

As used herein, the term noise is defined as an unwanted electrical signal. For example, an x-ray detector signal should theoretically comprise only an electrical response caused by detection of one or more x-ray events. However, electrical noise can be picked up, either by the x-ray detector, or through resistive, inductive, or capacitive coupling into the detector wiring. The noise may be detected or coupled from any of the above systems and added to the electrical response signal, as well as from sources external to the x-ray emitter/detector system. Additionally, mechanical vibrations can be inadvertently detected by the x-ray detector and converted to unintended electrical signals. These unintended signals can reduce the dynamic range of the actual detector signal that is associated with x-rays received at the detector.

To reduce these unintended noise signals, the subsystems are carefully packaged to reduce the amount of vibration and electrical noise that are transferred to the x-ray detector signal. As previously discussed, such packaging has practical limitations in noise reduction. In order to package x-ray emitter/detector systems in a convenient form factor for users, a certain amount of noise within the system has been deemed acceptable.

In order to reduce the level of electrical and mechanical noise in x-ray emitter/detector systems, advanced adaptive filtering algorithms can be used. For example, unintended noise in the x-ray detector signal can be caused by both electrical and mechanical noise that is inadvertently detected by the detector and converted to electrical noise on the x-ray detector signal. Adaptive filtering algorithms can be applied to substantially remove unintended noise on the detector signal. In one embodiment, the use of adaptive filtering algorithms can reduce the need for complex and expensive mechanical and electrical isolation that is currently used to minimize noise in the x-ray emitter/detector system. In addition, adaptive filtering can be used to assist and enhance the mechanical and electrical isolation systems to further reduce the noise level on the x-ray detector signal, thereby enabling x-ray measurements with more dynamic range and higher signal to noise ratios.

In the traditional architecture example illustrated in FIG. 1, the large number of asynchronous clocks operating in the multiple subsystems creates a large number of asynchronous electrical and mechanical noise sources within the x-ray emitter/detector system. Each of these noise sources may also emit spurs, harmonics, and cause additional resonant frequencies within the packaging or other electronic subsystems. These frequencies can shift as the system changes in temperature. The resulting large number of uncorrelated noise sources over a relatively wide range of frequencies can be difficult to reduce using adaptive filtering. The cost and complexity of filtering systems required to track and filter each of these uncorrelated frequencies can be substantial, thereby limiting the effectiveness of using adaptive filtering to reduce noise in the x-ray emitter/detector system.

It has been discovered that the effectiveness of adaptive filtering to remove noise in the x-ray detector signal can be substantially increased by redesigning the system architecture to allow the noise sources to be more deterministic. In one embodiment, the noise sources present on the x-ray detector signal can be made more deterministic by synchronizing at least some of the subsystems that are operating within the x-ray emitter/detector system.

For example, FIG. 2 illustrates an exemplary x-ray emitter/detector system architecture 200 that takes advantage of a master clock 202 at the system level. Rather than having each subsystem or component using a separate, asynchronous clock, the use of a master clock to drive the subsystems and components within the x-ray emitter/detector system enables periodic noise sources that can be more easily removed using adaptive filtering. This will be discussed more fully below.

In the exemplary system architecture illustrated in FIG. 2, the master clock 202 can operate at a selected frequency, such as 100 MHz. The master clock signal 203 can be communicated to each of the subsystems and/or components needing a clock source within the x-ray emitter/detector system. Alternatively, the master clock signal may be communicated only to those subsystems and/or components that are considered to be a contributing noise source at the detector signal. The master clock signal may be divided, multiplied, and/or phase locked to achieve a clock with a desired frequency and phase for a selected subsystem or component.

For example, the FPGA 206 or the CPU Clock 218 may run at 500 MHz. The master clock signal 203 frequency can be multiplied by 5 to achieve the desired clock frequency. The digital signal processor (DSP) 210 may operate at 50 MHz. The master clock signal frequency can be divided by two to provide the clock for the DSP. The analog to digital converter (A/D) or the diode bias supply charge pump 234 may operate at the master clock frequency, enabling the master clock signal to be sent directly to the subsystem or component clock. Additionally, phase lock loops 220 can be used to ensure that various sub-systems or components, such as the high voltage switching supply 222, the x-ray tube filament voltage 224, and the bias supply for the detector diode 226, are operated at a desired frequency and phase relative to the master clock. The master clock signal 203 can be communicated to each of the subsystems and components, as illustrated in FIG. 2. Alternatively, the clock signal may be daisy chained to multiple components and subsystems throughout the x-ray emitter/detector system, as can be appreciated.

The use of a master clock enables the various electrical signals within the x-ray emitter/detector system to have a related frequency and in some cases, a related phase. This relation enables noise sources that create noise that couples to signals, such as the x-ray detector signal, to be more deterministic. In a system where all clocks are deterministic, periodic noise sources are also periodic with respect to the sampling and processing logic. By providing the sample noise cancellation signals that can be used to indicate the periodicity of the noise to signal processing logic, or by separating the periodic noise from a desired signal using various filtering methods, noise cancellation can be achieved in using time domain/frequency domain subtractive methods, or adaptive filters.

An adaptive filter is a filter that can be automatically adjusted based on an optimizing algorithm used to adjust the filter's transfer function. Adaptive filters are typically implemented as digital filters due to the complexity of the optimizing algorithm. The performance of the adaptive filter is typically adapted based on an input signal using digital signal processing. A static filter typically involves the use of static filter coefficients. These filter coefficients collectively form a transfer function. In an adaptive filter, the filter coefficients are adaptive. Parameters based on a desired processing operation are not known in advance. A feedback mechanism is used to refine the values of the filter coefficients to provide a desired frequency response from the adaptive filter.

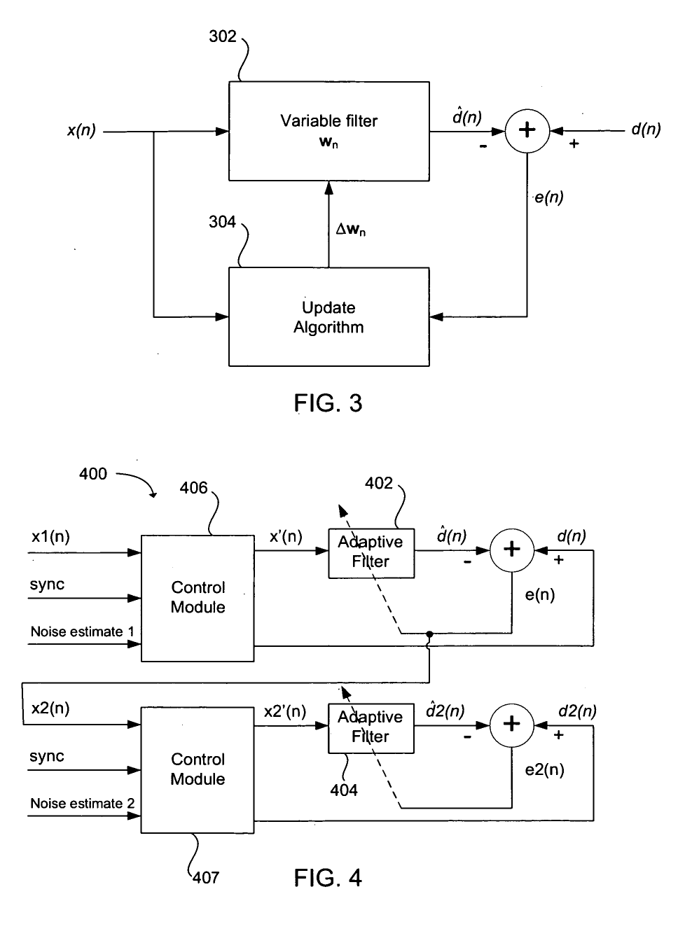

FIG. 3 illustrates a typical block diagram of an adaptive filter. In this illustration, the input x(n) to the variable filter block 302 is the sum of a desired signal d(n) and interfering noise v(n) that occurs on the desired signal. This can be shown as:

x(n)=d(n)+v(n)

In an x-ray emitter/detector system, the input x(n) may be an x-ray detector signal. The x-ray detector signal would be comprised of the desired, noise free detector signal d(n) and the noise v(n) that is interfering with the detector signal.

The variable filter 302 is typically comprised of a finite impulse response (FIR) type filter, although an infinite impulse response type filter can also be used in some situations. For a FIR type filter, the impulse response is equal to the filter coefficients. The coefficients for a filter of order p are defined as:

wₙ=[ωₙ(0), ωₙ(1), ωₙ(2), . . . , ωₙ(p)]^{T},

where T is an integer that is selected based on the type of update algorithm that is used. The error signal e(n) is the difference between the desired signal d(n) and the estimated signal d̂(n):

e(n)=d(n)−d̂(n).

The variable filter estimates the desired signal by convolving the input signal with the impulse response. In vector notation, this is expressed as:

d̂(n)=wₙ^{T}x(n),

where

x(n)=[x(n), x(n−1), . . . , x(n−p)]^{T}

is an input signal vector. The variable filter updates the filter coefficients at every time instant as:

wₙ₋₁=wₙ+Δwₙ

where Δwₙ is a correction factor for the filter coefficients. The adaptive update algorithm 304 generates this correction factor based on the input signal x(n) and the error signal e(n).

There are a variety of different types of adaptive algorithms that can be used to update the filter coefficients. Commonly used update algorithms include the least mean square (LMS) algorithm and the recursive least squares algorithm (RLS). Another update algorithm is the Kalman algorithm. The selection of a specific algorithm to be used in conjunction with an adaptive filter can depend on the properties of the algorithms and the properties of the overall signal which is to be filtered.

For example, the Kalman algorithm typically provides excellent performance that allows an adaptive algorithm to quickly converge to provide a desired filtering response. The performance of the Kalman algorithm depends on the accuracy of a priori assumptions. The performance can be less than impressive if the assumptions are erroneous. The Kalman algorithm is also computationally demanding. The algorithm requires [ωₙ(p)]² operations per sample (a value of T=2). This can limit the utility of Kalman filters in high rate real time applications.

In contrast, the LMS algorithm only requires [ωₙ(p)] operations per sample (a value of T=1), thereby enabling much more efficient operation than the Kalman algorithm. Additionally, no prior assumptions are needed for the LMS algorithm to estimate the signal. However, the LMS algorithm can have a slow rate of convergence. Other types of update algorithms, such as the fast affine projection (FAP), fast transversal filter (FTF) can also be used.

In the present application, the Kalman algorithm may be used as the update algorithm in one or more adaptive filters in x-ray emitter/detector systems that can have sudden changes in noise. Additionally, the algorithm may be useful for specific types of x-ray emitter/detectors. For example, in systems designed for x-ray diffraction, a large number of x-rays may be emitted and detected over a short period. The generation of the x-rays over this short period may cause sudden power and temperature changes in the system, thereby causing the frequency of the electrical and mechanical noise to change. The Kalman algorithm can be used to more quickly adapt to changes in the noise, thereby enabling the algorithm to quickly adapt when a large burst of x-rays causes a change in the noise on the x-ray detector signal. Additionally, the use of a system clock, as previously discussed, can enable substantially accurate a priori assumptions to be made with respect to the noise, since most noise sources will have a direct correlation with the system clock.

Alternatively, the LMS algorithm may be more useful for inexpensive systems that include less computational power or other types of systems such as x-ray fluorescence systems in which the noise sources and x-ray emissions can be relatively constant.

The number of filter coefficients, also referred to as the filter length, is typically selected based on the length (time span) of noise in the channel. The time period of the noise on the x-ray detector signal can be fairly short for electrical noise that is picked up by the x-ray detector or the wiring or cabling that is connected to the x-ray detector. For example, a 50 MHz signal may be inadvertently transmitted by wiring connected to the digital signal processor. This signal may be picked up at a sufficient power to interfere with the x-ray detection signal output by the x-ray detector. The repetitive, high frequency nature of this noise source enables an adaptive filter with a relatively short filter length to be used. Conversely, mechanical noise that is detected by the x-ray detector may be at a much lower frequency, from tens of hertz on up to hundreds of kilohertz. Additionally, this mechanical noise can have spurs, echoes, and harmonics. The mechanical noise may resonate within the system for a certain period. A sufficient number of filter coefficients can be selected to provide a filter length that will remove electrical noise in the x-ray detector signal that is caused by the mechanical noise. The filter length can be designed to enable the mechanical noise to be removed for a selected period that allows the amplitude of the mechanical vibrations, echoes and harmonics to be filtered to decrease the noise amplitude to a desired amplitude.

If the sampling frequency in an adaptive filter is F, then the sample time is 1/Fₛ or Tₛ. The noise time span in the channel is T_{ch}. The filter length can be defined as:

Fₗₑₙ=T_{ch}/Tₛ.

The complexity of each filter is then Fₛ*Fₗₑₙ. For example, if the sampling frequency in the adaptive filter is selected to be 50 MHz and a filter length of 30 filter coefficients is chosen, the adaptive filter must perform 1.5 billion multiply accumulates per second. An FPGA, such as a Xilinx, can be designed to provide calculations at tens of billions of multiply accumulations per second.

In order to efficiently filter both high frequency electrical noise caused by electrical sources and lower frequency electrical noise caused by mechanical sources, a plurality of adaptive filters can be used. It can be more efficient to use a lower complexity adaptive filter having a lower number of filter coefficients when a noise source has a shorter duration. Each adaptive filter can be designed to filter one or more noise sources. For example, FIG. 4 illustrates a system 400 that includes first 402 and second 404 adaptive filters connected in series. The first adaptive filter can be used to filter a first noise source v1(n) that is included in the input signal x1(n). The first noise source may be electrical noise in the x-ray detector signal that is caused by mechanical vibrations in the system that are detected by the x-ray detector and converted to an unwanted electrical signal. A sync signal can be used to place the adaptive filter in a blanking or training status, depending upon the operation of the system.

The adaptive filter can be designed with a filter length sufficient to substantially remove the electrical noise in the detector signal caused by the mechanical vibrations. A noise estimate can be used as an input to the adaptive filter. The noise estimate is a signal that has a linear correlation with the noise in the system. For example, the mechanical noise may be caused by the expansion and contraction of the high voltage power source at a switching frequency. In one embodiment, the clock used to drive the switching frequency can be used as a noise estimate. The coefficients in the adaptive filter can then be updated using a desired update algorithm.

In one embodiment, the same type of update algorithm can be used for each adaptive filter. Alternatively, the type of update algorithm can be selected based on the type of signal that is being filtered, the amount of processing power that is available, and other system design constraints, as can be appreciated. In the example above, the noise in the detector signal is caused by the mechanical vibrations that are detected by the x-ray detector. If this noise is fairly constant, a simple update algorithm, such as the LMS algorithm can be used to update the filter coefficients. Alternatively, if the noise on the detector signal caused by the mechanical vibrations is substantially irregular, or even pseudo-random, a more complex update algorithm such as the Kalman algorithm, or another update algorithm can be selected to update the filter coefficients. A properly selected update algorithm can enable the adaptive filter to substantially remove the noise on the x-ray detector signal that is caused by the switching power supply and output a signal e(n) that is substantially free of electronic noise caused by one or more mechanical vibration sources.

The output e(n) of the first adaptive filter 402, can then be used as an input x2(n) at the second adaptive filter 404. The input of the second adaptive filter can be substantially free from mechanical noise caused by the switching power supply. However, the input signal X2(n) may still have substantial electrical noise caused by other mechanical or electrical sources, as previously discussed. The second adaptive filter can be designed with a selected number of filter coefficients and a desired update algorithm to filter one or more additional noise sources from the x-ray detector. Additional adaptive filters can be connected in series to remove one or more noise sources at each successive filter. The number of filters can be selected based on an x-ray emitter/detector's system requirements. For example, the number of filters may be based on the number of noise sources in the system, the amount of correlation between the noise sources, the desired signal to noise ratio (SNR) of the x-ray detector signal, and so forth. Sufficient noise can be removed from the detector signal using adaptive filtering to provide the desired SNR.

In one embodiment, each adaptive filter can include a control module 406, 407. The control module can be used to train the adaptive filter. Each adaptive filter requires a certain period of time for the output to converge to a desired signal using the feedback loop e(n), e2(n). The feedback loop enables the update algorithm to update the filter coefficients in order to minimize the error signal, and thereby output a desired signal minus the noise filtered by the adaptive filter. A training period can be selected in which the x-ray emitter/detector system is not actually performing a critical measurement to allow the adaptive filter to converge. This training period may be a period as short as a few microseconds to as long as several hundred milliseconds. For example, in the x-ray emitter/detector system, the detector typically has leakage current. The leakage current increases a ramp voltage from a range of −2 volts to approximately +2 volts. At this point, the detector is reset and the ramp voltage returns to the −2 volt range. In one embodiment, the reset time takes approximately 12 microseconds. During this time, the adaptive filter may be run for a sufficient length to allow the adaptive filter to converge and output a desired signal when the detector is in operation.

Various other training periods may also be used. For example, the x-ray emitter/detector system can include a metal shutter used to safeguard the emittance of x-ray radiation from the system. The system can be designed to enable the x-ray source to be activated for a certain time period while the metal shutter is closed. A plurality of adaptive filters used to remove noise in the x-ray detector signal may be trained while the system is powered and before the metal shutter is opened to allow the x-ray radiation to be directed at its intended source.

While examples have been given for use of adaptive filtering in the time domain, adaptive filtering can also be accomplished in the frequency domain and the wavelet domain. For example, the update algorithm can be based on the discrete Fourier transform, the discrete cosine transform, a discrete wavelet transform, and the like. Filtering in the frequency or wavelet domain can provide substantial advantages over time domain filtering. For example, in the time domain, there are 50 million samples per second when the adaptive filter is operated at 50 MHz. Each of these 50 million samples are given equal processing time. However, only a small percentage of the samples actually contain information useful in filtering noise from the signal. In the wavelet domain, it is possible to determine which coefficients contain the energy of the signal. In a typical signal, most of the energy of the signal is represented by a small fraction of the wavelet coefficients. For example, 99.9% of the energy may be contained in ten percent of the wavelet coefficients. The computational complexity can be calculated as the sample rate times the percentage of wavelet coefficients that include a predetermined amount of energy times the number of operations per sample. Thus, the computational complexity in the above example, with only ten percent of the wavelet coefficients containing power greater than the predetermined level, is only 5 million samples per second if there is one operation per sample. Therefore, more complex forms of adaptive filtering and/or adaptive filtering of more noise sources can be accomplished with substantially less computational complexity in the wavelet domain than is typically possible in the time domain.

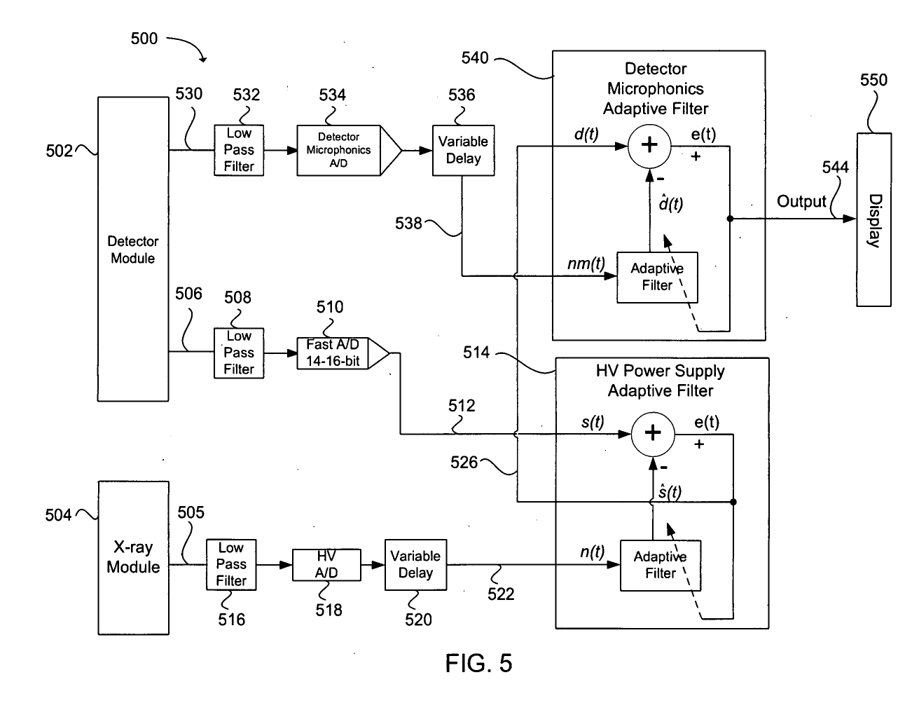

An exemplary diagram of an x-ray emitter/detector system 500 incorporating a plurality of adaptive filters to filter a plurality of noise sources is illustrated in FIG. 5. The system includes a detector module 502 and an x-ray module 504. The detector module can output a detector analog signal 506. The detector analog signal is the signal output by the x-ray detector. The signal can comprise the electrical response of the detector to photons received at the detector in the x-ray section of the electromagnetic spectrum. The signal can also include unwanted electrical noise caused by mechanical vibrations and electromagnetic interference, as previously discussed.

The analog detector signal 506 can be filtered using a low pass filter 508 and converted 510 to a digital signal 512 s(t). A low pass filter can be used to limit anti-aliasing, among other things. The digital signal is then sent to a first adaptive filter module 514. In this exemplary embodiment, the first adaptive filter module is used to remove electrical noise on the x-ray detector signal that is caused by mechanical vibrations and electromagnetic interference that results from the high voltage power source used to drive the x-ray tube. The high voltage power source may be contained in the x-ray module 504.

A high voltage noise sample signal 505 that is correlated with the electrical noise caused by the high voltage power source can be output from the x-ray module 504. For example, the sample signal may be a sine wave that is correlated with or synchronized with the switching frequency of a high voltage power supply. The switching frequency of the power supply may vary from tens of kilohertz to hundreds of kilohertz depending on the type of power supply and the load conditions placed on the supply. The sample signal 505 can be filtered with a low pass filter 516, converted 518 to a digital signal, and sent through a variable delay 520. The variable delay can be used to temporally adjust the sample signal so that it substantially aligns with the noise in the detector signal. Temporally aligning the sample signal with the noise enables the number of taps in the adaptive filter (i.e. the length of the adaptive filter) to be decreased, thereby reducing the computational complexity of the adaptive filter and update algorithm.

The output of the variable delay 520 comprises a noise sample signal n(t) 522 that is substantially temporally aligned with noise on the digital detector signal s(t) 512. The two signals are input to the high voltage power supply adaptive filter module 514. An update algorithm, such as the LMS, RLS, or Kalman algorithm can be used to update the filter coefficients in the adaptive filter. The adaptive filter can output a filtered signal ŝ(t) and an error signal e(t). The error signal is used as a feedback to the adaptive signal. The values of the filter coefficients are adjusted to minimize the error signal and provide a filtered signal ŝ(t) comprising the x-ray detector signal with noise that is correlated with the high voltage power supply substantially filtered from the detector signal.

The noise correlated with the high voltage power supply may include a number of sources, including mechanical noise associated with the expansion and contraction of the high voltage supply as it is switched, along with various electrical noise caused by electrical interference of the detector signal with the power supply, the electrical signals output from the supply, and the various spurs and harmonics of these electrical signals. Each of these electrical signals will likely have a strong correlation with the switching frequency, thereby enabling the digital x-ray detector signal 512 to be correlated with the noise sample signal n(t) 522 and allow the adaptive filter to substantially remove the correlated noise from the signal s(t) 512 that is associated with the high voltage power supply.

In the exemplary embodiment illustrated in FIG. 5, the second adaptive filter module is used to remove electrical noise on the x-ray detector signal caused by mechanical vibrations. These mechanical vibrations may be caused by sources that are internal to or external from the x-ray emitter/detector system. The mechanical vibrations may be random or quasi-random, thereby making the vibrations difficult to predict.

One way of predicting the vibrations is though the use of microphonics detectors. Microphonics is the phenomenon where certain components in electronic devices transform mechanical vibrations into an undesired electrical signal. In the example illustrated in FIG. 5, the x-ray detector in the detector module 502 is one electronic device that transforms mechanical vibrations into unwanted electrical noise. At least one additional microphonics detector, such as an accelerometer, gyroscope, or broadband microphone may be located in the detector module 502 near the x-ray detector. The microphonics detector can be used to detect the same mechanical vibrations that are detected at the x-ray detector and convert the vibrations to an electronic signal that can be correlated with the noise on the x-ray detector signal caused by the mechanical vibrations.

The microphonics detector signal 530 can be filtered using a low pass filter 532, converted to a digital signal with an analog to digital converter 534, and sent through a variable delay 536. The variable delay can be used to temporally adjust the microphonics detector signal so that it aligns with the noise in the x-ray detector signal. A delay may exist between the signals due to the physical separation of the microphonics detector(s) and the x-ray detector. The actual timing difference can depend on the speed of sound within the x-ray emitter/detector system. Temporally aligning the microphonics signal with the noise on the x-ray detector signal enables the number of taps in the adaptive filter (i.e. the length of the adaptive filter) to be decreased, thereby reducing the computational complexity of the adaptive filter and update algorithm in the detector microphonics adaptive filter module 540. Temporally aligning the microphonics signal with the noise on the x-ray detector signal can also improve filter convergence time in noisy environments.

The output of the variable delay 536 comprises a mechanical noise sample signal nm(t) 538 that is substantially temporally aligned with noise on the filtered x-ray digital detector signal e(t) 526. The output e(t) 526 of the high voltage power supply adaptive filter module 514 can be an input signal d(t) in the detector microphonics adaptive filter module 540. The mechanical noise sample signal nm(t) and the filtered x-ray digital detector signal d(t) are input to the detector microphonics adaptive filter module. An update algorithm, such as the LMS, RLS, or Kalman algorithm can be used to update the filter coefficients in the adaptive filter. The adaptive filter can output an error signal e(t). The error signal is used as a feedback to the adaptive signal. The values of the filter coefficients are adjusted to minimize the error signal and provide a filtered signal e(t) comprising the x-ray detector signal with noise correlated with the microphonics detector substantially filtered from the x-ray detector signal.

The output 544 of the detector microphonics adaptive filter module 540 comprises the x-ray detector signal with electronic noise correlated with the high voltage power supply and the microphonics detector substantially reduced. The output signal can then be sent to one or more additional adaptive filter modules where specific types of electrical noise can be correlated with noise on the output signal and filtered. The output signal can then be amplified to enable the x-ray detector signal to be analyzed by a user. For example, the amplified output of the x-ray detector maybe viewed on a display 550. Additional processing and amplification of the x-ray detector signal may be needed prior to its display. The reduction of the noise on the signal can provide a cleaner display by reducing unintended signals and enabling the dynamic range of the amplifier to be based on the actual x-ray detector signal rather than on noise that may be substantially greater than the detector signal. This enables a substantially better display of the x-ray detector signal to be produced for the user.

The adaptive filter modules 514, 540 and other electrical components illustrated in the exemplary embodiment of FIG. 5 can be constructed, for example, using one or more field programmable gate array (FPGA) chips, a digital signal processing (DSP) chip, an application specific integrated circuit (ASIC), or some combination of these chips or other microprocessing architectures. The x-ray emitter/detector system 500 can be created using software, firmware, hardware, or some combination. Additional filtering and processing of an x-ray detector signal can also be provided to achieve a desired response from the x-ray detector, as can be appreciated.

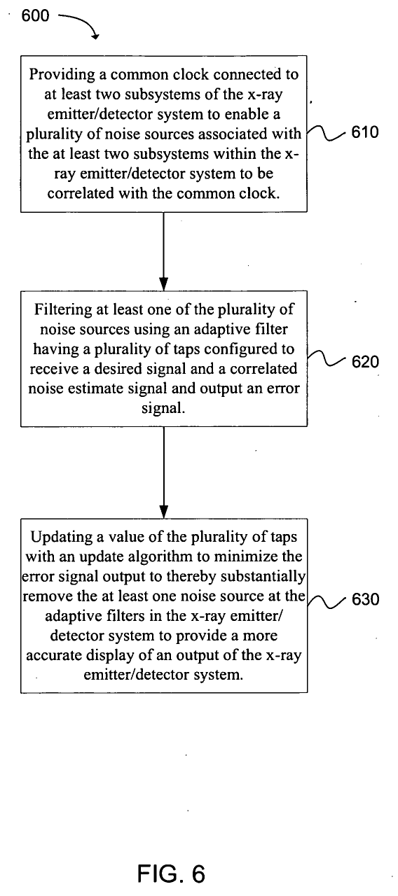

In another embodiment, a method 600 for reducing signal noise in an x-ray emitter/detector system is disclosed, as illustrated in the flow chart depicted in FIG. 6. The method includes the operation of providing 610 a common clock connected to at least two subsystems of the x-ray emitter/detector system to enable a plurality of noise sources associated with the at least two subsystems within the x-ray emitter/detector system to be correlated with the common clock. At least one of the plurality of noise sources is filtered 620 using an adaptive filter having a plurality of taps. The filter is configured to receive a desired signal and a correlated noise estimate signal and output an error signal. A value of the plurality of taps is updated 630 with an update algorithm to minimize the error signal output. The error signal output is minimized to thereby substantially remove the at least one noise source at the adaptive filters in the x-ray emitter/detector system to provide a more accurate display of an output of the x-ray emitter/detector system. For example, noise on an x-ray detector signal that is caused by one or more noise sources in the x-ray emitter/detector system may be substantially removed using one or more adaptive filters. The noise sources also may be external to the x-ray emitter/detector system, such as vibrations that are caused outside the system. By reducing the amount of noise on the x-ray detector, the detector signal can be more accurately amplified and displayed, thereby producing a more accurate image of an x-ray response of a desired object using the x-ray emitter/detector system.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A signal noise reduction system for an x-ray emitter/detector system, comprising:
a common clock connected to at least two subsystems of the x-ray emitter/detector system to enable a plurality of noise sources associated with the at least two subsystems within the x-ray emitter/detector system to be correlated with the common clock;
at least one adaptive filter having a plurality of taps configured to receive a desired signal and a correlated noise estimate signal and output an error signal;
an update algorithm used to update a value of the plurality of taps to minimize the error signal output to thereby substantially remove at least one of the plurality of noise sources at each of the at last one variable filters in the x-ray emitter/detector system to provide a more accurate display of an output of the x-ray emitter/detector system.

2. A signal noise reduction system as in claim 1, wherein the at least two subsystems are selected from the group consisting of a high voltage switching power supply, an x-ray tube filament supply, a diode bias supply charge pump, a field programmable gate array, a digital signal processor, an analog to digital converter, and a computer processing unit.

3. A signal noise reduction system as in claim 1, wherein the variable filter is one of a finite impulse response filter and an infinite impulse response filter.

4. A signal noise reduction system as in claim 1, wherein a clock signal output by the common clock is multiplied by a selected value to increase the clock signal frequency by the selected value.

5. A signal noise reduction system as in claim 1, wherein a clock signal output by the common clock is divided by a selected value to decrease the clock signal frequency by the selected value.

6. A signal noise reduction system as in claim 1, wherein a clock signal output by the common clock is coupled to at least one phase lock loop to enable the at least two subsystems to operate substantially in phase with the common clock.

7. A signal noise reduction system as in claim 1, wherein a same type of update algorithm is used for each of the at least one adaptive filters.

8. A signal noise reduction system as in claim 1, wherein at least two different types of update algorithms are used to update at least two adaptive filters, respectively.

9. A signal noise reduction system as in claim 1, further comprising a training period having a length selected to enable the update algorithm to update a value of the plurality of taps in the at least one adaptive filter until the error signal is less than a desired threshold value to allow the adaptive filter to converge and output a desired signal.

10. A signal noise reduction system as in claim 9, wherein the training period is selected to coincide with a time in which the x-ray emitter/detector system is not actually performing a critical measurement.

11. A signal noise reduction system as in claim 1, wherein the update algorithm is performed in at least one of a time domain, a frequency domain, and a wavelet domain.

12. A signal noise reduction system as in claim 1, further comprising at least one variable delay used to temporally adjust a sample noise signal with noise on an x-ray detector signal to reduce a number of taps in the adaptive filter, thereby reducing the computational complexity of the adaptive filter and update algorithm.

13. A signal noise reduction system for an x-ray emitter/detector system, comprising:
a plurality of adaptive filters;
a first correlated noise estimate of a first noise source on a signal in the x-ray emitter/detector system;
a first of the plurality of adaptive filters configured to receive the first correlated noise estimate to enable noise related to the first noise source to be substantially removed from the signal and output a filtered signal substantially free of the noise related to the first noise source;
an additional correlated noise estimate of a further noise source on the signal in the x-ray emitter/detector system;
a subsequent adaptive filter of the plurality of adaptive filters configured to receive the filtered signal and the additional correlated noise estimate to enable noise related to the further noise source to be substantially removed from the filtered signal and output a further filtered signal substantially free of the further noise source to enable a plurality of noise sources on the signal to be removed in the x-ray emitter/detector system using the plurality of adaptive filters to provide a more accurate display of the signal.

14. A signal noise reduction system as in claim 13, wherein the signal is an x-ray detector signal.

15. A signal noise reduction system as in claim 14, wherein the plurality of adaptive filters are operable to filter a single noise source from the x-ray detector signal.

16. A signal noise reduction system as in claim 14, wherein at least one of the plurality of adaptive filters is operable to filter multiple noise sources from the x-ray detector signal.

17. A signal noise reduction system as in claim 13, wherein the plurality of adaptive filters each include a selected number of taps to filter a desired signal, with a value of each tap being updated with an update algorithm configured to minimize an error signal associated with each adaptive filter, and each update algorithm is selected to minimize the error signal in a selected amount of time.

18. A signal noise reduction system as in claim 13, wherein the first adaptive filter is operable to filter signal noise associated with a high voltage power supply and the subsequent adaptive filter is operable to filter signal noise caused by mechanical vibrations detected with detector microphonics.

19. A method for reducing signal noise in an x-ray emitter/detector system, comprising:
providing a common clock connected to at least two subsystems of the x-ray emitter/detector system to enable a plurality of noise sources associated with the at least two subsystems within the x-ray emitter/detector system to be correlated with the common clock;
filtering at least one of the plurality of noise sources using an adaptive filter having a plurality of taps configured to receive a desired signal and a correlated noise estimate signal and output an error signal;
updating a value of the plurality of taps with an update algorithm to minimize the error signal output to thereby substantially remove the at least one noise source at the adaptive filters in the x-ray emitter/detector system to provide a more accurate display of an output of the x-ray emitter/detector system.

20. A method as in claim 19, further comprising updating a value of each of the plurality of taps with the update algorithm, wherein the update algorithm is performed in at least one of a time domain, a frequency domain, and a wavelet domain.
